(19) United States
(12) Patent Application Publication
(10) Pub. No.: US 2008/0018713 A1
(43) Pub. Date: Jan. 24, 2008

(54) MULTI-CRYSTALLINE SILICON DEVICE AND MANUFACTURING METHOD

(76) Inventors: Ali G. Lopez, Pittsford, NY (US); Constantine N. Anagnostopoulos, Mendon, NY (US); Joseph Jech, Webster, NY (US)

Correspondence Address: Mark G. Bocchetti;Patent Legal Staff, Eastman Kodak Company, 343 State Street, Rochester, NY, 14650-2201, US

(21) Appl. No.: 11/459,059

(22) Filed: Jul. 21, 2006

(51) Int. Cl. B41J 2/045

(52) U.S. Cl. 347/68

(57) ABSTRACT

A printhead includes a multi-crystalline silicon substrate including a surface with portions of the multi-crystalline silicon substrate defining a liquid channel. A nozzle plate structure is disposed on the surface of the multi-crystalline silicon substrate with portions of the nozzle plate structure defining a nozzle. The nozzle is in fluid communication with the liquid channel. A drop forming mechanism is associated with the nozzle plate structure and is controllably operable to form either a liquid drop from a continuous liquid stream flowing through the nozzle or eject a liquid drop on demand from liquid present in the nozzle.

### FIELD OF THE INVENTION

This invention relates generally to devices made from silicon substrates and manufacturing techniques used to fabricate these devices and, in particular, to devices made from multi-crystalline silicon substrates and manufacturing techniques used to fabricate device made from multi-crystalline silicon substrates.

### BACKGROUND OF THE INVENTION

Devices, for example, drop on demand and continuous liquid ejection devices, made from single crystalline silicon substrates are known and often include at least one via formed in the single crystalline silicon substrate portion of the device. However, the use of single crystalline silicon substrates for these devices is disadvantaged in terms of size, shape, and cost. Single crystalline silicon substrates are typically available in only circular shapes having diameters less than twelve inches (approximately 30.5 centimeters). As such, additional fabrication processes are often necessary to reshape the circular substrate to the intended shape, for example, a square or rectangle, of the device. The material cost associated with single crystalline silicon substrates also increases as the size of the substrate increases. For example, the material cost of a single crystalline substrate having a diameter of twelve inches is significantly increased when compared to the material cost of a single crystalline substrate having a one inch (2.54 centimeters) diameter. Accordingly, as the size requirement of devices traditionally made from single crystalline silicon substrates increases, the cost of single crystalline silicon often limits or prohibits its use in the new larger device even though single crystalline silicon was used in the original smaller device.

One solution has been to use non-silicon substrates when fabricating devices having increased size requirements. For example, U.S. Pat. No. 6,663,221 B2, issued to Anagnostopoulos et al. on Dec. 16, 2003, discloses pagewide drop on demand and continuous inkjet printheads in which a nozzle array, heaters, drivers and data carrying circuits are integrated on a non-silicon substrate.

However, there is still a need to make devices, like those currently made from single crystalline silicon, that satisfy increased device size requirements without having one or more of the disadvantages associated with single crystalline silicon.

### SUMMARY OF THE INVENTION

According to one feature of the invention, a printhead includes a multi-crystalline silicon substrate including a surface with portions of multi-crystalline silicon substrate defining a liquid channel. A nozzle plate structure is disposed on the surface of the multi-crystalline silicon substrate with portions of the nozzle plate structure defining a nozzle. The nozzle is in fluid communication with the liquid channel. A drop forming mechanism is associated with the nozzle plate structure and is controllably operable to form either a liquid drop from a continuous liquid stream flowing through the nozzle or eject a liquid drop on demand from liquid present in the nozzle.

According to another feature of the invention, a method of forming a printhead includes providing a multi-crystalline silicon substrate; performing a process on a surface of the multi-crystalline silicon substrate; providing a nozzle plate structure disposed on the surface of the multi-crystalline silicon substrate; and providing a drop forming mechanism associated with the nozzle plate structure.

According to another feature of the invention, a multi-crystalline substrate device includes a substrate having a first crystal and a second crystal. The first crystal has an orientation distinct from an orientation of the second crystal. A first hole is located at least partially in the first crystal and a second hole is located at least partially in the second crystal.

### BRIEF DESCRIPTION OF THE DRAWINGS

In the detailed description of the preferred embodiments of the invention presented below, reference is made to the accompanying drawings, in which:

FIG. 1 is a schematic cross sectional view of an example embodiment of the invention;

FIG. 2 is a top view of a multi-crystalline silicon (mc-Si) substrate;

FIG. 3A is a schematic perspective view of the mc-Si substrate shown in FIG. 2;

FIG. 3B is a schematic cross sectional side view of a portion of the mc-Si substrate shown in FIG. 3A prior to a polishing process being performed on the mc-Si substrate;

FIG. 3C is a schematic cross sectional side view of a portion of the mc-Si substrate shown in FIG. 3A after the polishing process has been performed on the mc-Si substrate;

FIG. 4A is a schematic top view of a mc-Si substrate;

FIG. 4B is a schematic cross sectional view of the mc-Si substrate shown in FIG. 4A taken along line 4A-4A with a material layer disposed over a surface of the mc-Si substrate;

FIG. 5A is a schematic top view of a mc-Si substrate;

FIG. 5B is a schematic cross sectional view of the mc-Si substrate shown in FIG. 5A taken along line 5A-5A with a plurality of material layers disposed over a surface of the mc-Si substrate;

FIG. 6A is a schematic top view of another example embodiment of the invention;

FIG. 6B is a schematic cross sectional view of the example embodiment of the invention shown in FIG. 6A;

FIG. 6C is a schematic cross sectional view of an alternative example embodiment of the invention shown in FIG. 6A;

FIG. 7A is a schematic top view of another example embodiment of the invention;

FIG. 7B is a schematic cross sectional view of the example embodiment of the invention shown in FIG. 7A;

FIG. 7C is a schematic cross sectional view of an alternative example embodiment of the invention shown in FIG. 7A;

FIG. 8A is a schematic top view of another example embodiment of the invention;

FIG. 8B is a schematic cross sectional view of the example embodiment of the invention shown in FIG. 8A;

FIG. 8C is a schematic cross sectional view of an alternative example embodiment of the invention shown in FIG. 8A;

FIG. 9A is a schematic cross sectional view of another example embodiment of the invention; and

FIG. 9B is a schematic cross sectional view of an alternative example embodiment of the invention shown in FIG. 9A.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art. In the following description, identical reference numerals have been used, where possible, to designate identical elements.

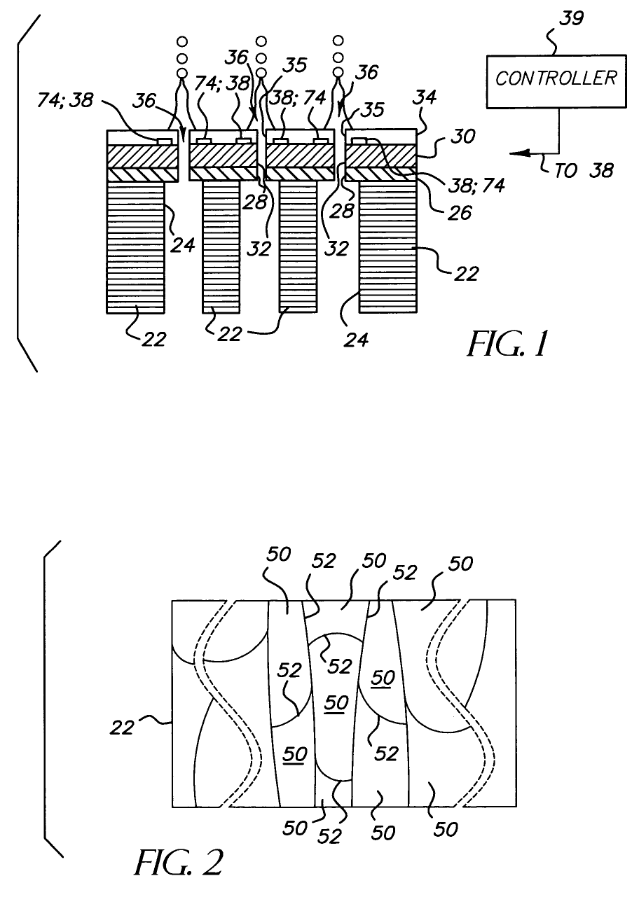

Referring to FIG. 1, a printhead 20 is shown. Printhead 20 includes a multi-crystalline silicon (mc-Si) substrate 22 in which a plurality of delivery channels 24 are formed. A nozzle plate structure 25 is disposed on a surface of the mc-Si substrate 22. Nozzle plate structure 25 is formed, typically in layers deposited on mc-Si substrate 22, as part of the printhead formation process.

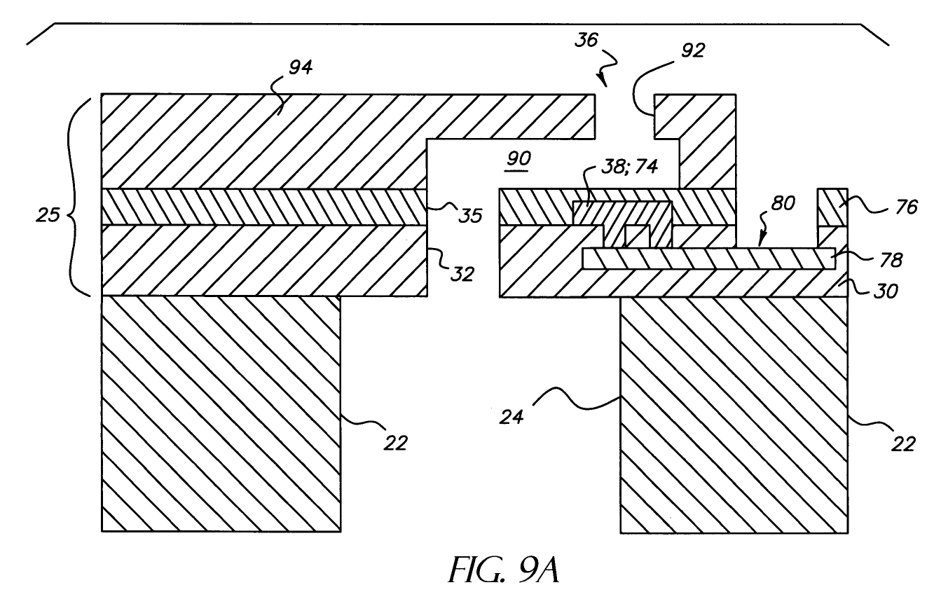

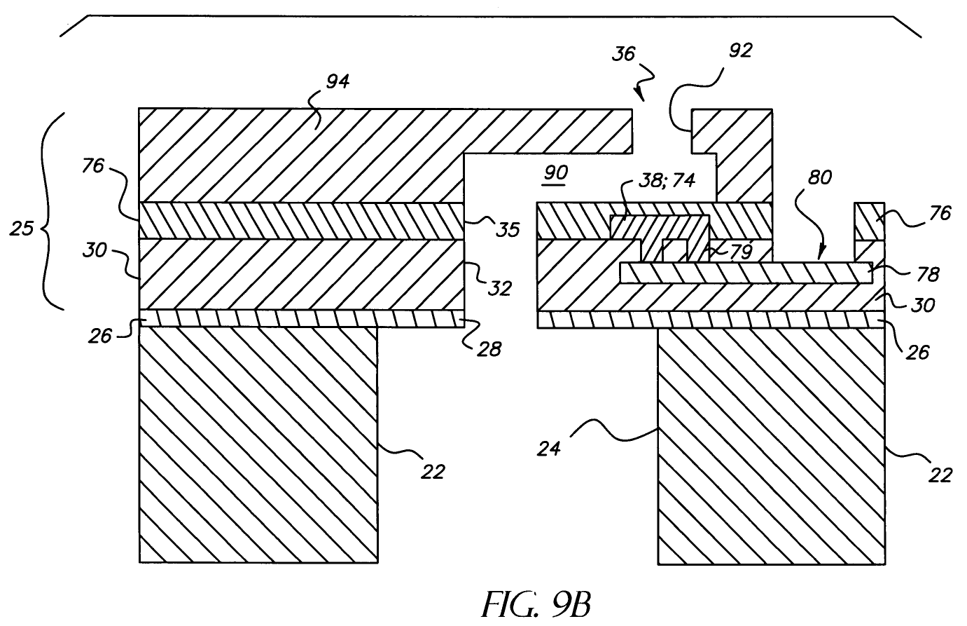

In the embodiment shown in FIG. 1, nozzle plate structure 25 includes a conductive material layer 26, a dielectric material layer 30, and a passivation/protection material layer 34. Conductive material layer 26 is disposed on one surface of mc-Si substrate 22 and includes a plurality of delivery channels 28 formed therein. Dielectric material layer 30 is disposed on a surface of conductive conduct layer 26 not contacting mc-Si substrate 22. Dielectric material layer 30 includes a plurality of delivery channels 32 formed therein. Passivation/protection material layer 34 is disposed on a surface of dielectric material layer 30 not contacting conductive material layer 26. Passivation/protection material layer 34 includes a plurality of delivery channels 35 formed therein. Delivery channels 24, 28, 32, 35 are in liquid communication with each other. One or more of delivery channels 24, 28, 32, 35 forms nozzle 36. Nozzle 36 can take the form of a bore as shown in FIGS. 1, 6B, 6C, 7B, 7C, 8B, 8C, or a chamber as shown in FIGS. 9A, 9B.

Printhead 20 includes a drop forming mechanism 38 associated with the nozzle plate structure 25. Drop forming mechanism 38 is controllably operable or actuatable using a controller 39 to form either a liquid drop from a continuous liquid stream flowing through nozzle 36, commonly referred to as continuous liquid drop printing, or eject a liquid drop on demand from liquid present in nozzle 36 (or 40 as described below), commonly referred to as drop on demand liquid printing. In the embodiment shown in FIG. 1, drop forming mechanism 38 is a heater 74 positioned about each nozzle 36 although other types of drop forming mechanisms, for example, piezoelectric actuators, acoustic actuators, can be used in the invention.

Referring to FIG. 2, a multi-crystalline silicon (mc-Si) substrate 22 is shown. Multi-crystalline Silicon (mc-Si) substrates can easily be grown in non-circular shapes to have much larger sizes, for example, a rectangular shape with dimensions 14 inches by 18 inches, or 21 inches by 25 inches, when compared to single crystalline silicon substrates. Mc-Si substrates are also less expensive to produce than single crystalline silicon substrates.

Mc-Si substrate 22 includes a plurality of grains or crystals 50 (a first crystal, a second crystal, etc.) and grain or crystal boundaries 52. As each grain or crystal 50 has a distinct orientation when compared to other grains or crystals 50, an etch rate associated with one grain or crystal 50 is distinct from an etch rate associated with another grain or crystal 50.

Referring to FIGS. 3A through 3C, multi-crystalline silicon substrate 22 has an inherently rough top surface 54. For some applications, for example, a printhead 22 application, a smooth (for example, equal to or less than 10 A surface roughness) top surface 56 is preferred. To achieve this, one or more processes are performed on surface 56 to polish surface 56. Surface 56 is polished by performing a grinding process and a chemical mechanical planarization (CMP) process both known in the art. The ratio of removal rates between the two processes is optimized to obtain the desired smoothness of surface 56. Typically, a CMP process alone does not lead to a smooth surface due to the grain dependent chemical etch rate of the multi-crystalline silicon substrate 22.

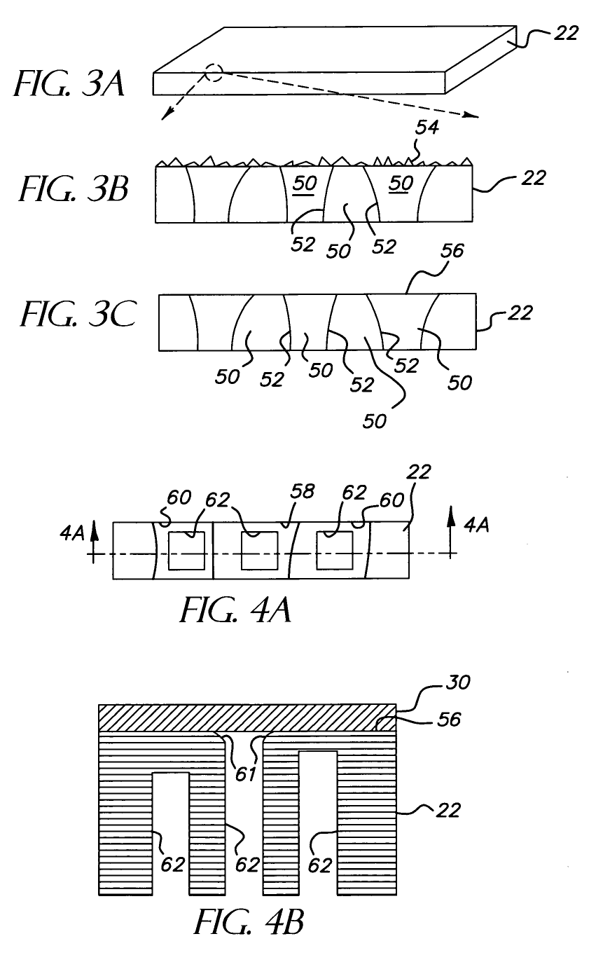

Referring to FIGS. 4A and 4B, multi-crystalline silicon substrate 22 is shown with a dielectric material layer 30 disposed over polished surface 56. For some applications, for example, a printhead 22 application, vias or hole(s) 62, for example, delivery channels 24, are formed in or through mc-Si substrate 22 using an etching process, for example, a reactive ion etching process or a deep reactive ion etch (DRIE) process. As the different grains or crystals 50 of mc-Si substrate 22 have different etch rates due to different crystal planes or orientations, a grain region 58 with the fastest etch rate will expose an etch stop layer, dielectric material layer 30 in this instance, before other grain regions 60. Notching can result when the etch ions contact the stop layer, dielectric material layer 30. This results in a variation in the dimensions of vias or holes 62.

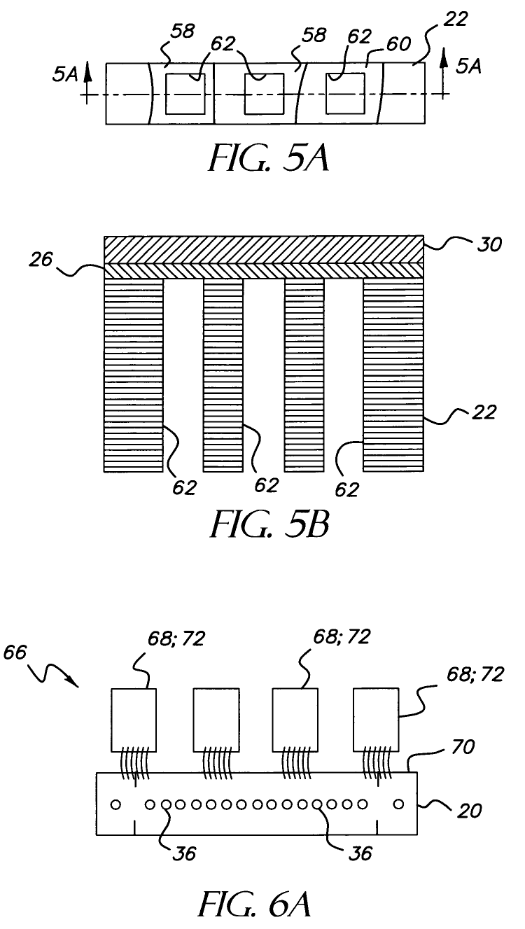

When vias or holes 62 having similar or substantially consistent dimensions are desired in mc-Si substrate 22, an electrically conducting material layer 26, for example, a tantalum silicon nitride (TaSiN) layer, can be used to reduce or even prevent notching. Referring to FIGS. 5A and 5B, electrically conducting material layer 26 is disposed over mc-Si substrate 22. Dielectric material layer 30 is then disposed over electrically conducting material layer 26. The presence of electrically conducting material layer 26 reduces or even prevents the etch ion charge build up which reduces the likelihood of the etch ions spreading out to create the notching effect.

Alternatively, dielectric layer 30 can be deposited over mc-Si substrate 22 and then conductive material layer 26, for example, an aluminum (Al) layer, can be disposed over dielectric material layer 30. In this situation, conductive material layer 26 is typically removed after etching of mc-Si substrate 22 is complete.

In this manner, a via or hole 62 can be etched in adjacent grains or crystals 50 of mc-Si substrate 22 and completely contained within each grain or crystal 50. Alternatively, a via or hole 62 can be etched in adjacent grains or crystals 50 of mc-Si substrate 22 such that via or hole 62 passes at least partially through a plurality of grains or crystals 50 and the grain boundary 52 located between the grains or crystals.

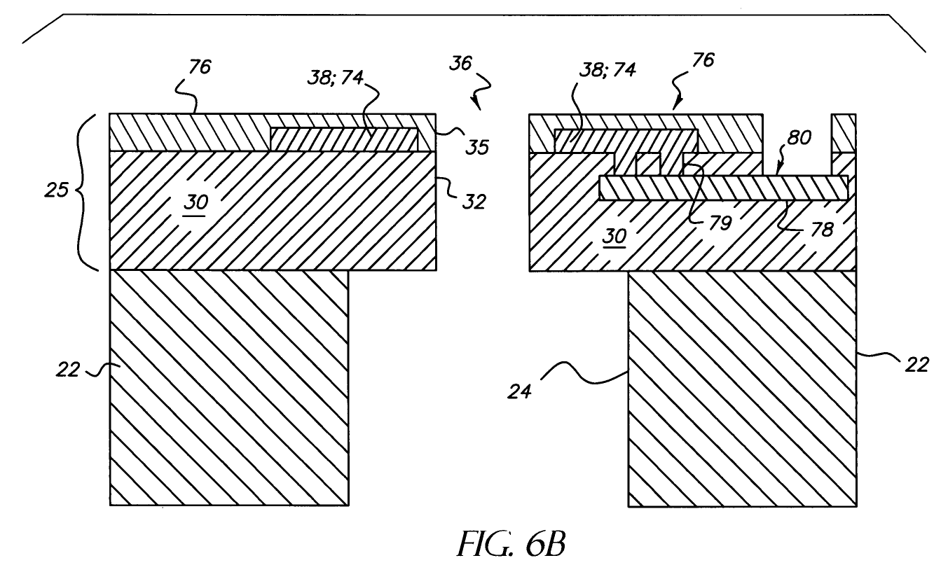

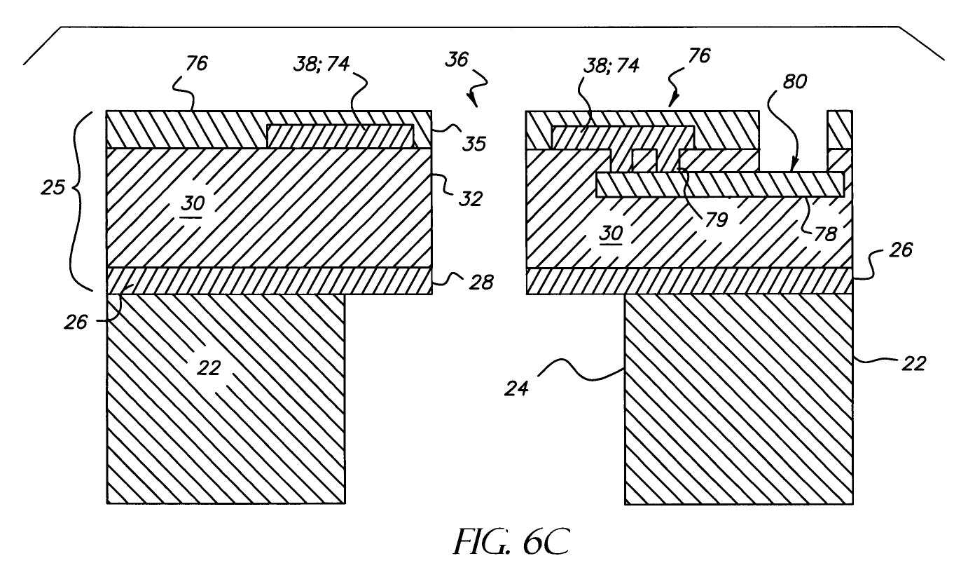

Referring to FIG. 6A, a hybrid printhead 66 is shown. Hybrid printhead 66 includes printhead 20 and driver electronics, also referred to as logic control circuitry 68 physically separate from printhead 20. Printhead 20 includes a plurality of nozzles 36 and associated drop forming mechanisms 38 formed on mc-Si substrate 22. Driver electronics or logic control circuitry 68 are in electrical communication with drop forming mechanisms 38 through at least one electrical connection 70 located on printhead 20. A power source 72 is also located physically separated from printhead 20 and is in electrical communication with drop forming mechanisms 38.

Referring to FIG. 6B, mc-Si substrate 22 of printhead 20 includes delivery channel 24 formed using, for example, a dry etch process such as a deep reactive ion etch (DRIE) process. Nozzle plate structure 25 includes dielectric material layer 30, for example, a silicon oxide (SiO₂) layer, disposed on a surface of mc-Si substrate 22. Drop forming mechanism 38, a heater 74 made from an electrically resistive material, for example, tantalum silicon nitride (TaSiN), is disposed over dielectric material layer 30 and is in electrical communication with a conductive material layer 78, for example, an aluminum (Al) or copper (Cu) layer, formed in dielectric material layer 30 through via 79. A passivation/protection material layer 76, for example, a nitride/oxide (NiH₄/SiO₂) layer, is disposed over heater 74.

Nozzle 36 is created by forming delivery channels 35, 32 in passivation/protection material layer 76 and dielectric material layer 30 using, for example, a dry etch process such as a reactive ion etch (RIE) process. Heater 74, located about nozzle 36, can be, for example, a ring heater, a notch heater, a split heater, or other types of heaters known in the art.

A portion of conductive material layer 78 is exposed using, for example, a dry etch process such as an RIE process. The exposed portion of conducting material layer 78 forms a bond pad 80 which serves as electrical connection 70 for driver electronics or logic control circuitry 68 and/or power source 72.

Referring to FIG. 6C, when it is advantageous to form individual delivery channels 24 having similar or substantially consistent dimensions in mc-Si substrate 22, electrically conducting material layer 26, for example, a tantalum silicon nitride (TaSiN) layer, is disposed over mc-Si substrate 22 prior to disposing dielectric material layer 30 over electrically conducting material layer 26. Nozzle 36 is created by forming delivery channels 35, 32, 28 in passivation/protection material layer 76, dielectric material layer 30, and conductive material layer 26 using, for example, a dry etch process such as a reactive ion etch (RIE) process.

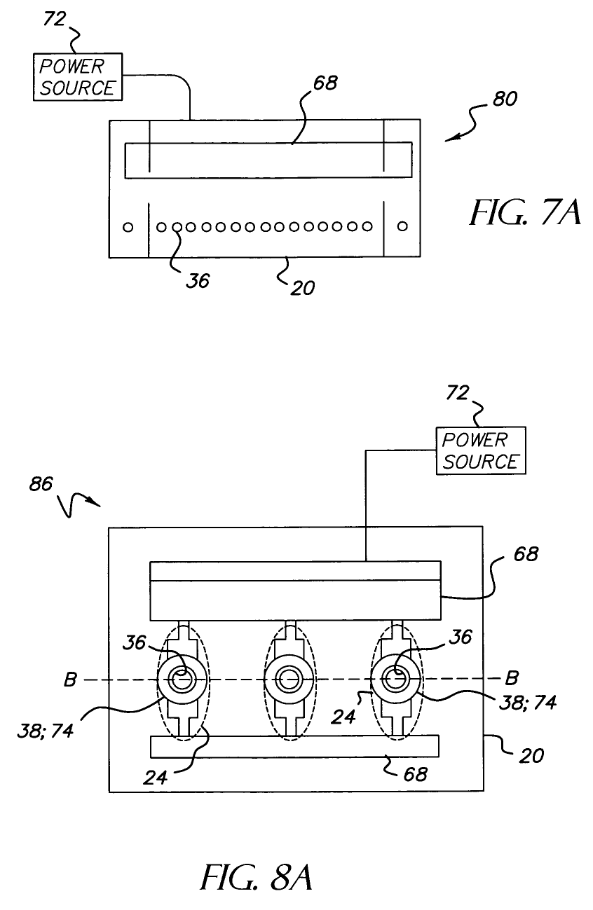

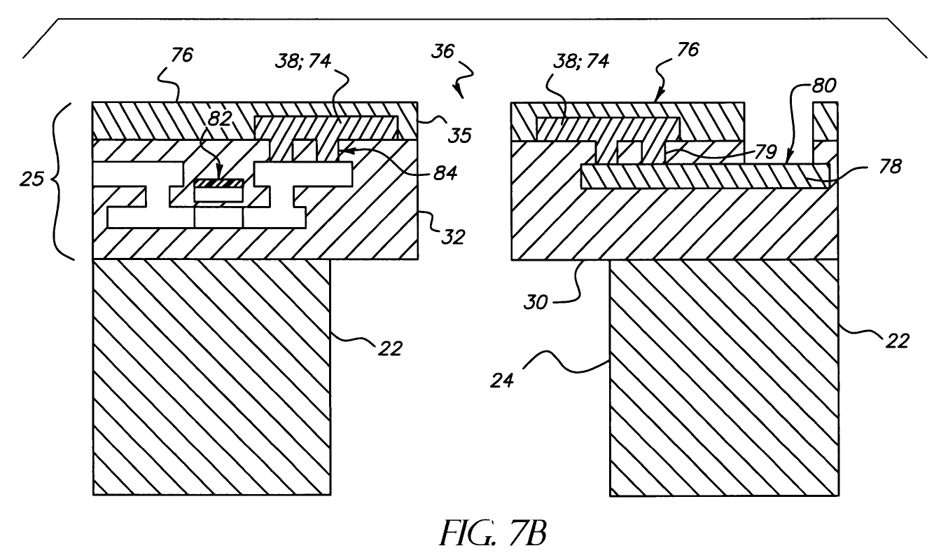

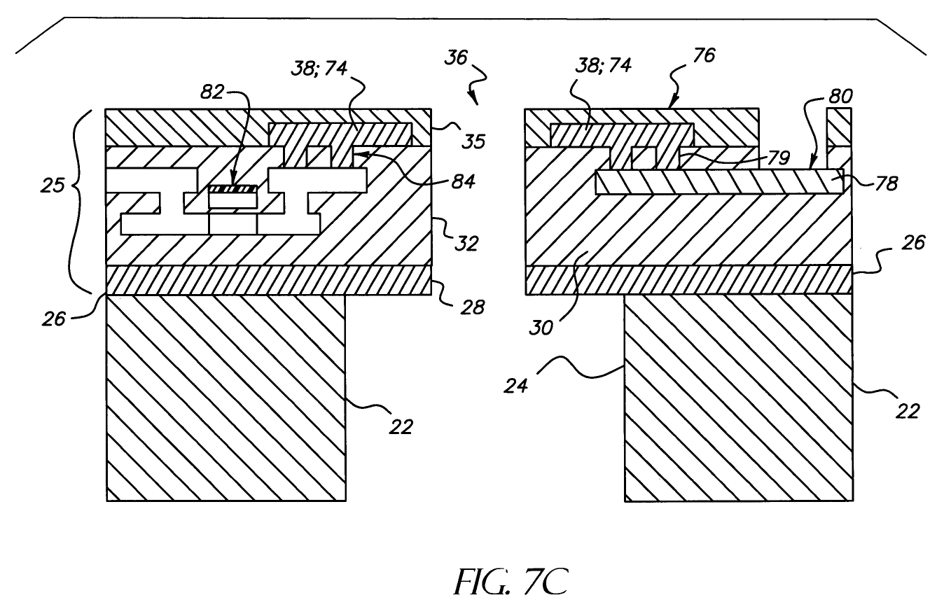

Referring to FIG. 7A, a monolithic printhead 80 is shown. Monolithic printhead 80 includes printhead 20 integrated with driver electronics or logic control circuitry 68 including, for example, thin film transistors (TFT) 82. Printhead 20 also includes a plurality of nozzles 36 and associated drop forming mechanisms 38 formed on mc-Si substrate 22. Driver electronics or logic control circuitry 68 are in electrical communication with drop forming mechanisms 38. A power source 72 is in electrical communication with drop forming mechanisms 38 of printhead 20.

Referring to FIG. 7B, mc-Si substrate 22 of printhead 20 includes delivery channel 24 formed using, for example, a dry etch process such as a deep reactive ion etch (DRIE) process. Nozzle plate structure 25 includes dielectric material layer 30, for example, a silicon oxide (SiO₂) layer, disposed on a surface of mc-Si substrate 22. Drop forming mechanism 38, a heater 74 made from an electrically resistive material, for example, tantalum silicon nitride (TaSiN), is disposed over dielectric material layer 30 and is in electrical communication with a conductive material layer 78, for example, an aluminum (Al) or copper (Cu) layer, formed in dielectric material layer 30 through via 79. A passivation/protection material layer 76, for example, a nitride/oxide (NiH₄/SiO₂) layer, is disposed over heater 74.

Driver electronics or logic control circuitry 68 including, for example, a thin film transistor (TFT) 82 are integrated into printhead 20. Thin film transistor (TFT) 82 is formed in dielectric material layer 30 using formation processes known in the art. Thin film transistor (TFT) 82 is electrically connected to heater 74 through via 84. When integrated into a printhead including a mc-Si substrate 22, improved performance of thin film transistors (TFT) 82 may result due to the higher processing temperature limits of mc-Si substrate 22 as compared to non-silicon substrates.

Nozzle 36 is created by forming delivery channels 35, 32 in passivation/protection material layer 76 and dielectric material layer 30 using, for example, a dry etch process such as a reactive ion etch (RIE) process. Heater 74, located about nozzle 36, can be, for example, a ring heater, a notch heater, a split heater, or other types of heaters known in the art.

A portion of conductive material layer 78 is exposed using, for example, a dry etch process such as an RIE process. The exposed portion of conducting material layer 78 forms a bond pad 80 which serves as electrical connection 70 for power source 72.

Referring to FIG. 7C, when it is advantageous to form individual delivery channels 24 having similar or substantially consistent dimensions in mc-Si substrate 22, electrically conducting material layer 26, for example, a tantalum silicon nitride (TaSiN) layer, is disposed over mc-Si substrate 22 prior to disposing dielectric material layer 30 over electrically conducting material layer 26. Nozzle 36 is created by forming delivery channels 35, 32, 28 in passivation/protection material layer 76, dielectric material layer 30, and conductive material layer 26 using, for example, a dry etch process such as a reactive ion etch (RIE) process.

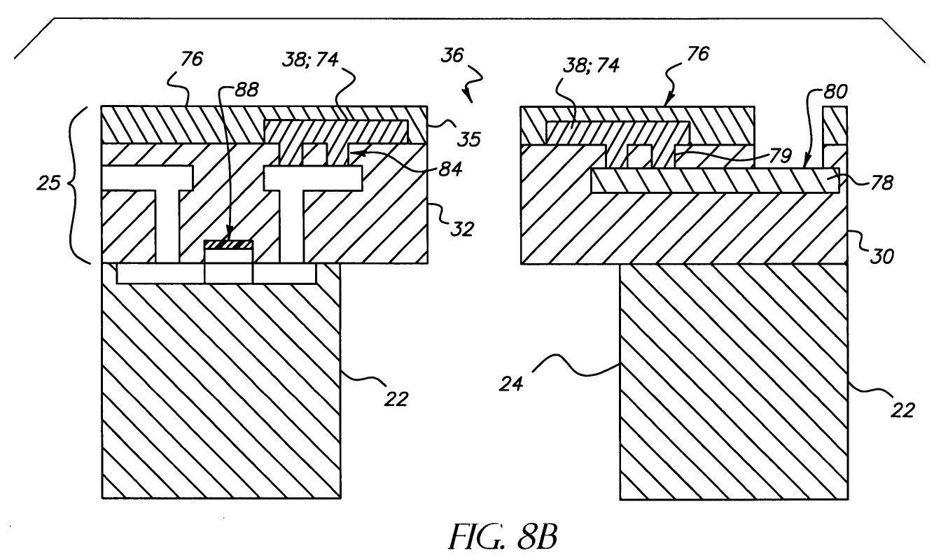

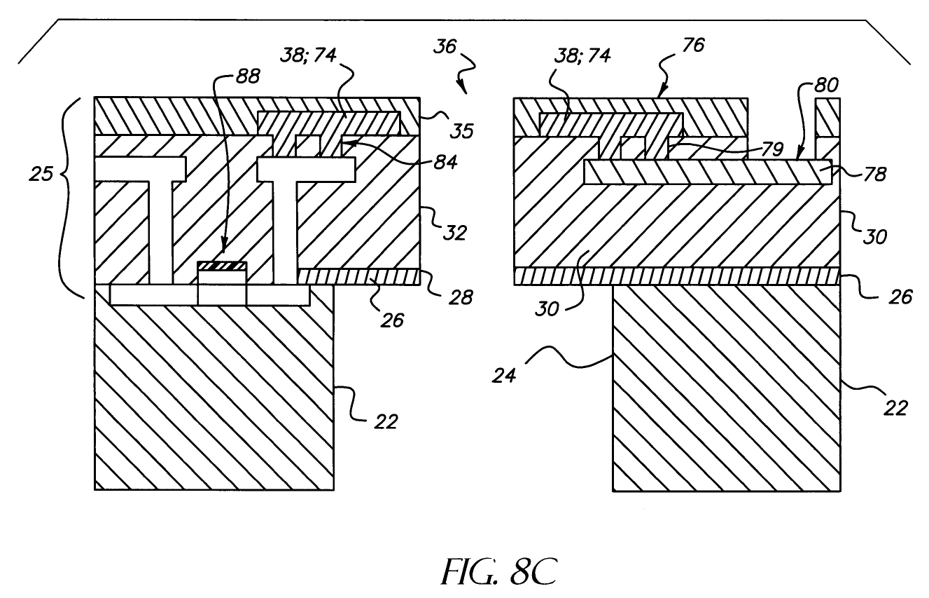

Referring to FIG. 8A, another embodiment of a monolithic printhead 86 is shown. Monolithic printhead 86 includes printhead 20 integrated with driver electronics or logic control circuitry 68 including, for example, bulk transistors 88. Printhead 20 also includes a plurality of nozzles 36 and associated drop forming mechanisms 38 formed on mc-Si substrate 22. Driver electronics 68 are in electrical communication with drop forming mechanisms 38. A power source 72 is in electrical communication with drop forming mechanisms 38 of printhead 20.

Referring to FIG. 8B, mc-Si substrate 22 of printhead 20 includes delivery channel 24 formed using, for example, a dry etch process such as a deep reactive ion etch (DRIE) process. Nozzle plate structure 25 includes dielectric material layer 30, for example, a silicon oxide (SiO₂) layer, disposed on a surface of mc-Si substrate 22. Drop forming mechanism 38, a heater 74 made from an electrically resistive material, for example, tantalum silicon nitride (TaSiN), is disposed over dielectric material layer 30 and is in electrical communication with a conductive material layer 78, for example, an aluminum (Al) or copper (Cu) layer, formed in dielectric material layer 30 through via 79. A passivation/protection material layer 76, for example, a nitride/oxide (NiH₄/SiO₂) layer, is disposed over heater 74.

Driver electronics or logic control circuitry 68 including, for example, bulk transistors 88 are integrated into printhead 20. Bulk transistor 88 is formed at least partially in mc-Si substrate 22 and in dielectric material layer 30 using formation processes known in the art. Partially forming bulk transistor 88 in mc-Si substrate 22 can be accomplished by using known doping processes to dope portions of mc-Si substrate 22 to form at least the source and drain portion of bulk transistor 88. Dopants can include, for example, phosphorous, arsenic, boron, or combinations thereof. When bulk transistor 88 is at least partially formed in mc-Si substrate 22, mc-Si substrate 22 may help to dissipate more of the heat created by bulk transistor 88 as compared to heat dissipation characteristics of non-silicon substrates. Bulk transistor 88 is electrically connected to heater 74 through via 84.

Nozzle 36 is created by forming delivery channels 35, 32 in passivation/protection material layer 76 and dielectric material layer 30 using, for example, a dry etch process such as a reactive ion etch (RIE) process. Heater 74, located about nozzle 36, can be, for example, a ring heater, a notch heater, a split heater, or other types of heaters known in the art.

A portion of conductive material layer 78 is exposed using, for example, a dry etch process such as an RIE process. The exposed portion of conducting material layer 78 forms a bond pad 80 which serves as electrical connection 70 for power source 72.

Referring to FIG. 8C, when it is advantageous to form individual delivery channels 24 having similar or substantially consistent dimensions in mc-Si substrate 22, electrically conducting material layer 26, for example, a tantalum silicon nitride (TaSiN) layer, is disposed over mc-Si substrate 22 prior to disposing dielectric material layer 30 over electrically conducting material layer 26. Nozzle 36 is created by forming delivery channels 35, 32, 28 in passivation/protection material layer 76, dielectric material layer 30, and conductive material layer 26 using, for example, a dry etch process such as a reactive ion etch (RIE) process.

FIGS. 6A through 8C describe printheads 20 operable to create liquid drops in either a continuous or drop on demand manner in which drop forming mechanism 38 is located about nozzle 36. Other embodiments of printhead 20 include drop forming mechanism 38 being positioned at other locations relative to nozzle 36.

For example, and referring to FIG. 9A printhead 20 is shown in which drop forming mechanism 38 is operatively associated with nozzle 36. In this embodiment nozzle 36 is in the form of a chamber 90 including an opening 92. Drop forming mechanism 38 is positioned on a side of chamber 90 opposite that of opening 92.

Printhead 20 includes a plurality of nozzles 36 and associated drop forming mechanisms 38 formed on mc-Si substrate 22. Driver electronics or logic control circuitry 68 are in electrical communication with drop forming mechanisms 38. As described above, driver electronics or logic control circuitry 68 can be physically separate from printhead 20 or integrated with printhead 20. A power source 72 is also located physically separated from printhead 20 and is in electrical communication with drop forming mechanisms 38.

Mc-Si substrate 22 of printhead 20 includes delivery channel 24 formed using, for example, a dry etch process such as a deep reactive ion etch (DRIE) process. Nozzle plate structure 25 includes dielectric material layer 30, for example, a silicon oxide (SiO₂) layer, disposed on a surface of mc-Si substrate 22. Drop forming mechanism 38, a heater 74 made from an electrically resistive material, for example, tantalum silicon nitride (TaSiN), is disposed over dielectric material layer 30 and is in electrical communication with a conductive material layer 78, for example, an aluminum (Al) or copper (Cu) layer, formed in dielectric material layer 30 through via 79. A passivation/protection material layer 76, for example, a nitride oxide (NO₂) layer, is disposed over heater 74. Delivery channels 35, 32 are formed in passivation/protection material layer 76 and dielectric material layer 30 using, for example, a dry etch process such as a reactive ion etch (RIE) process.

A portion of conductive material layer 78 is exposed using, for example, a dry etch process such as an RIE process. The exposed portion of conducting material layer 78 forms a bond pad 80 which serves as electrical connection 70 for driver electronics or logic control circuitry 68 and/or power source 72.

Chamber 90 and opening 92 are formed using processes known in the art. For example, a sacrificial material layer (not shown) defining chamber 90 can be deposited over passivation/protection material layer 76 with another material layer 94 being deposited over the sacrificial material. Opening 92 is created in material layer 94 using an etching process. Chamber 90 is then formed by removing the sacrificial material either through opening 92 or through delivery channels 35, 32.

Referring to FIG. 9B, when it is advantageous to form individual delivery channels 24 having similar or substantially consistent dimensions in mc-Si substrate 22, electrically conducting material layer 26, for example, a tantalum silicon nitride (TaSiN) layer, is disposed over mc-Si substrate 22 prior to disposing dielectric material layer 30 over electrically conducting material layer 26. Delivery channel 28 is formed in conductive material layer 26 when delivery channels 35, 32 are formed using, for example, a dry etch process such as a reactive ion etch (RIE) process.

While printheads of any size can be made using mc-Si substrates, the use of mc-Si substrates is particular advantageous when making pagewide printheads. In a pagewide printhead, the length of the printhead is preferably at least equal to the width of the receiver and does not “scan” during printing. The length of the page wide printhead is scalable depending on the specific application contemplated and, as such, can range from less than one inch to lengths exceeding twenty inches. In the present invention, the length of the pagewide printhead is preferably greater than or equal to four inches, and more preferably greater than or equal to nine inches because it is in these length regions in which the cost, shape, and size disadvantages of single crystalline silicon start to become readily apparent.

Although the term printhead is used herein, it is recognized that printheads are being used today to eject other types of fluids and not just ink. For example, the ejection of various liquids including medicines, pigments, dyes, conductive and semi-conductive organics, metal particles, and other materials is possible today using a printhead. As such, the term printhead is not intended to be limited to just devices that eject ink.

The invention has been described in detail with particular reference to certain preferred embodiments thereof, but it will be understood that variations and modifications can be effected within the scope of the invention.

1. A printhead comprising:
a multi-crystalline silicon substrate including a surface, portions of multi-crystalline silicon substrate defining a liquid channel;
a nozzle plate structure disposed on the surface of the multi-crystalline silicon substrate, portions of the nozzle plate structure defining a nozzle, the nozzle being in fluid communication with the liquid channel; and
a drop forming mechanism associated with the nozzle plate structure, the drop forming mechanism being controllably operable to form either a liquid drop from a continuous liquid stream flowing through the nozzle or eject a liquid drop on demand from liquid present in the nozzle.

2. The printhead of claim 1, wherein the drop forming mechanism is a heater positioned in the nozzle plate structure.

3. The printhead of claim 1, further comprising:
control circuitry in electrical communication with the drop forming mechanism, the control circuitry being remotely positioned relative to the multi-crystalline silicon substrate.

4. The printhead of claim 3, the nozzle plate structure including a dielectric material layer disposed on the surface of the multi-crystalline silicon substrate and a conducting material layer at least partially located in the dielectric material layer, wherein the drop forming mechanism includes a resistive material layer disposed on the dielectric material layer, the resistive material layer being electrically connected to the conducting material layer, the conducting material layer being electrically connected to the control circuitry.

5. The printhead of claim 1, further comprising:
control circuitry in electrical communication with the heater, the control circuitry being positioned proximate to the multi-crystalline silicon substrate.

6. The printhead of claim 5, wherein the control circuitry includes a thin film transistor positioned in the nozzle plate.

7. The printhead of claim 6, the nozzle plate structure including a dielectric material layer disposed on the surface of the multi-crystalline silicon substrate, the thin film transistors being integrated into the dielectric material layer, wherein the drop forming mechanism includes a resistive material layer disposed on the dielectric material layer, the resistive material layer being electrically connected to the thin film transistor.

8. The printhead of claim 5, wherein the control circuitry includes a transistor at least partially located in the multi-crystalline silicon substrate.

9. The printhead of claim 8, the nozzle plate structure including a dielectric material layer disposed on the surface of the multi-crystalline silicon substrate, the transistor being at least partially integrated into the multi-crystalline silicon substrate, wherein the drop forming mechanism includes a resistive material layer disposed on the dielectric material layer, the resistive material layer being electrically connected to the transistor.

10. The printhead of claim 1, further comprising:
an electrically conducting material layer positioned between the nozzle plate and the multi-crystalline silicon substrate.

11. The printhead of claim 1, wherein the printhead is a pagewide printhead.

12. The printhead of claim 11, the pagewide printhead having a length, wherein the length is greater than or equal to 9 inches.

13. A method of forming a printhead comprising:
providing a multi-crystalline silicon substrate;
performing a process on a surface of the multi-crystalline silicon substrate;
providing a nozzle plate structure disposed on the surface of the multi-crystalline silicon substrate; and
providing a drop forming mechanism associated with the nozzle plate structure.

14. The method according to claim 13, wherein performing the process on the surface of the multi-crystalline silicon substrate includes polishing the multi-crystalline silicon substrate.

15. The method according to claim 14, wherein polishing the multi-crystalline silicon substrate includes grinding the surface of the multi-crystalline silicon substrate.

16. The method according to claim 14, wherein polishing the multi-crystalline silicon substrate includes using a chemical mechanical polishing process applied to the surface of the multi-crystalline silicon substrate.

17. The method according to claim 13, wherein performing the process on the surface of the multi-crystalline silicon substrate includes depositing a conductive layer on the surface of the multi-crystalline silicon substrate.

18. The method according to claim 17, wherein depositing the conductive layer on the multi-crystalline silicon substrate includes first depositing a dielectric layer on the multi-crystalline silicon substrate and then depositing the conductive layer on the dielectric layer.

19. The method of claim 18, further comprising:
using an etching process to form a delivery channel in the multi-crystalline silicon substrate; and
removing the conductive layer after the etching process is complete, wherein the dielectric layer forms at least a portion of the nozzle plate structure.

20. The method according to claim 17, wherein depositing the conductive layer on the substrate includes first depositing the conductive layer on the substrate and then depositing a dielectric layer on the conductive layer.

21. The method of claim 20, further comprising:
using an etching process to form a delivery channel in the multi-crystalline silicon substrate, wherein the dielectric layer forms at least a portion of the nozzle plate structure.

22. The method of claim 13, wherein providing the nozzle plate structure disposed on the surface of the multi-crystalline silicon substrate includes forming driver electronics operable to control the drop forming mechanism in the nozzle plate structure.

23. The method of claim 13, wherein providing the nozzle plate structure disposed on the surface of the multi-crystalline silicon substrate includes forming driver electronics operable to control the drop forming mechanism at least partially located in the multi-crystalline silicon substrate.

24. A multi-crystalline substrate device comprising:
a substrate having a first crystal and a second crystal, the first crystal having an orientation distinct from an orientation of the second crystal, a first hole being located at least partially in the first crystal, a second hole being located at least partially in the second crystal.
